(19) United States
(12) Patent Application Publication
(10) Pub. No.: US 2023/0033842 A1
(43) Pub. Date: Feb. 2, 2023

(54) ELECTRICAL CONNECTOR WITH IMPROVED TERMINAL HOLES

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YAN-YAN HAN, Kunshan (CN); XIAO-BO DU, Kunshan (CN); GUO-HUA ZHANG, Kunshan (CN); ZI-QIANG ZHU, Kunshan (CN)

(21) Appl. No.: 17/870,386

(22) Filed: Jul. 21, 2022

(30) Foreign Application Priority Data
Jul. 27, 2021 (CN) 202110850524.X

(51) Int. Cl. H01R 13/432

(52) U.S. Cl. CPC H01R 13/432

(57) ABSTRACT

An electrical connector includes: an insulative housing defining a terminal hole, the terminal hole defining two opposite narrow sides and two opposite wide sides; and a first terminal having a fixing portion fixed in the terminal hole, the fixing portion having two opposite narrow surfaces and two opposite wide surfaces, the narrow surfaces defining barbs interference fit with the narrow sides of the terminal hole, wherein the fixing portion further defines a tab protruding from one wide surface thereof, the terminal hole further defines a front groove with a blocking face and a rear groove with a guiding face, and the tab passes across the guiding face to press against the blocking face for preventing the fixing portion from moving rearward.

### BACKGROUND OF THE DISCLOSURE

### 1. Field of the Disclosure

The present disclosure relates to an electrical connector including terminals inserted into a housing thereof.

### 2. Description of Related Arts

China Patent Publication No. CN105305133A discloses an electrical connector comprising a housing and a plurality of terminals retained in the housing. Each terminal comprises a retained portion. The retained portion comprises a first pressing part and a second pressing part. The terminals are inserted rearward into and interference fit with the terminal grooves from a front end of the housing, which can prevent burrs produced during terminal insertion from falling in the mating cavity. However, in most electrical connectors, terminals are installed from the rear end of the housing, plastic burrs produced during insertion of the terminals will fall into the mating cavity.

Therefore an improved electrical connector is desired to overcome said problem.

### SUMMARY OF THE DISCLOSURE

An object of the invention is to provide an electrical connector to improve insertion of terminals to an insulative housing thereof.

In order to achieve above-mentioned object, an electrical connector comprises: an insulative housing defining a terminal hole, the terminal hole defining two opposite narrow sides and two opposite wide sides; and a first terminal having a fixing portion fixed in the terminal hole, the fixing portion having two opposite narrow surfaces and two opposite wide surfaces, the narrow surfaces defining barbs interference fit with the narrow sides of the terminal hole, wherein the fixing portion further defines a tab protruding from one wide surface thereof, the terminal hole further defines a front groove with a blocking face and a rear groove with a guiding face, and the tab passes across the guiding face to press against the blocking face for preventing the fixing portion from moving rearward.

Other objects, advantages and novel features of the disclosure will become more apparent from the following detailed description when taken in conjunction with the accompanying drawings.

### BRIEF DESCRIPTION OF THE DRAWINGS

FIG. 1 is a perspective view of an electrical connector of this present invention;

FIG. 2 is an another perspective view of FIG. 1, wherein four terminals are exploded;

FIG. 3 is an enlarged view of FIG. 2 in box C;

FIG. 4 is an enlarged rear perspective view of the terminal hole of FIG. 3;

FIG. 5 is a cross-sectional view of the electrical connector taken along lines 5-5 and an enlarged view in box of FIG. 1;

FIG. 6 is a cross-sectional view of the electrical connector of FIG. 1 taken along lines 6-6;

FIG. 7 is a perspective view of three terminals of FIG. 2;

FIG. 8 is an another perspective view of FIG. 7;

FIG. 9 is a top perspective view of FIG. 7; and

FIG. 10 is an enlarged view of FIG. 2 in another box D.

### DETAILED DESCRIPTION OF THE PREFERRED EMBODIMENT

An electrical connector 100 of one embodiment of the invention is used in a vehicle application, which has a plurality of power terminals for transmitting large or high current and a plurality of signal terminals for transmitting signal. In structure, the power terminals are larger than the signal terminals in size. These high power electrical connectors require highly stabled elements, for example, a large holding force of the terminals is required.

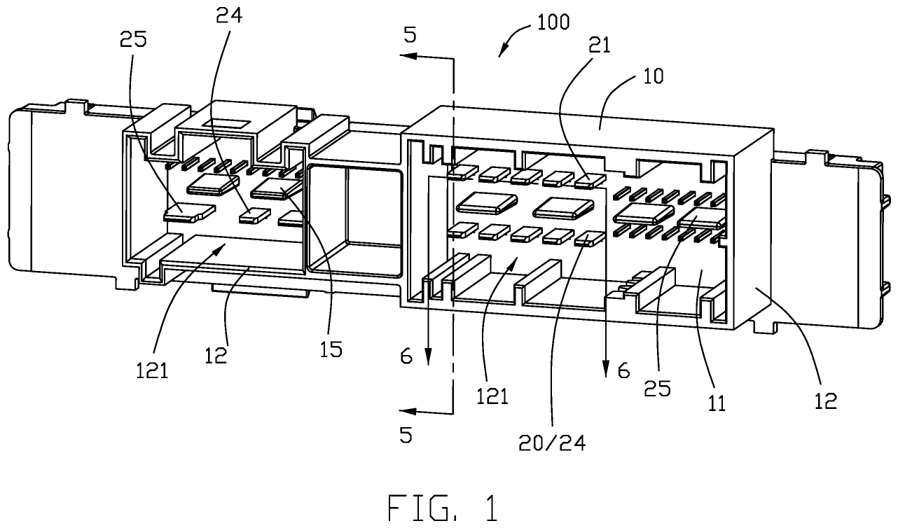

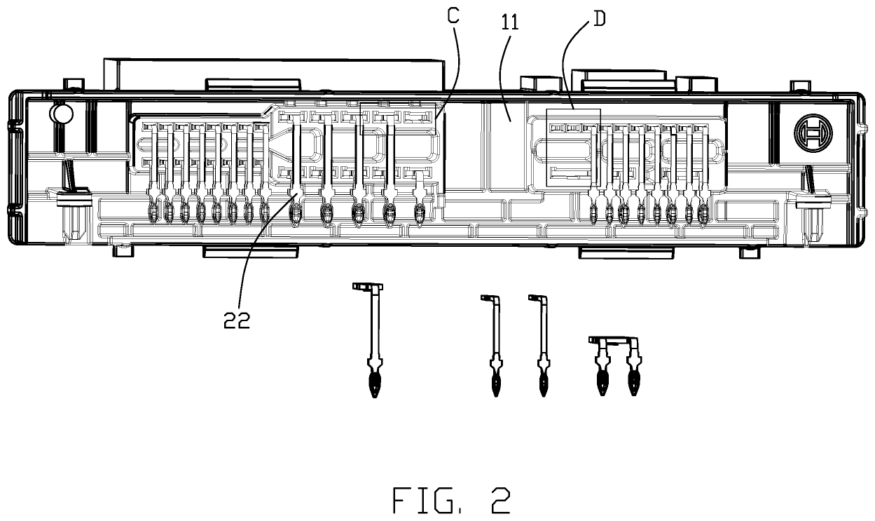

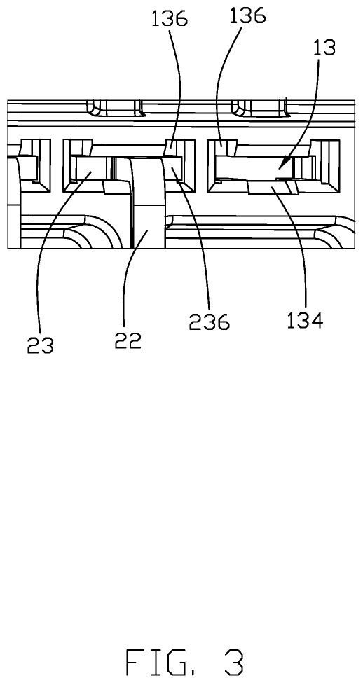

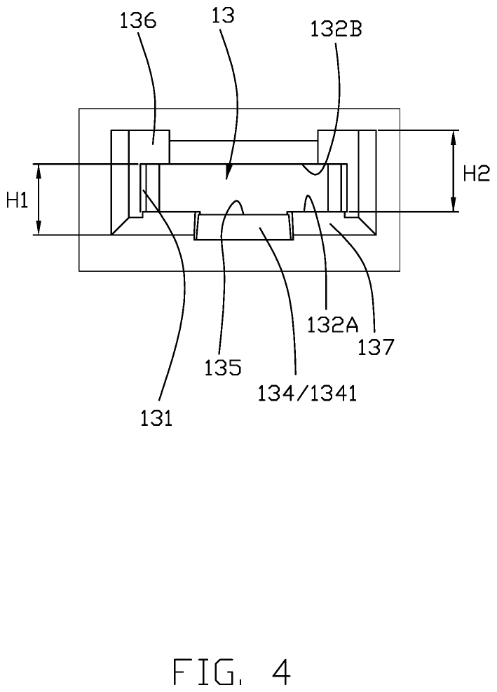

Referring to FIGS. 1 and 2, the electrical connector 100 comprises an insulative housing 10 and a plurality of terminals 20 fixed thereon. In this embodiment, the electrical connector 100 is a right-angle connector. The insulative housing 10 comprises a base wall 11 and a surrounding wall 12 extending forwards therefrom. The surrounding wall 12 defines a mating cavity 121 extending from the front surface of the base wall 11 and opening forward. The terminal 20 basically comprises a contact portion 21 extending forwards into the mating cavity 121 and a soldering portion 22 extending rearwards out of the rear surface 111 of the base wall 11. As shown in FIGS. 3-4, the insulative housing 10 defines a plurality of terminal holes 13, each terminal 20 comprises a fixing portion 23 fixed in the terminal hole 13, the contact portion 21 is located in front of the fixing portion 23, and the soldering portion 22 is located behind the fixing portion 23. Notably, a mating direction is defined in a front-to-back direction and a mating connector is inserted from a front face of the insulative housing 10 and then into the mating cavity 121. In this embodiment, two surrounding walls 12 extend forwards and form two mating cavity 121, as shown in FIG. 1, the left mating cavity 121 includes two rows of terminals, and the right mating cavity 121 includes four rows of terminals. The terminals 20 substantially comprise a first type of terminals/first terminals 24 with a larger size for high power and a second type of terminals/second terminals 25 with a smaller size for signal. The first/power terminal 24 is of a flat structure and generally used for transmitting large current. The first terminals 24 are further divided into two kinds of first terminals, the structure of two kinds of first terminals is substantially same to each other, and the slight differences between two kinds of first terminals 24 is the size and the structure of the soldering portion 22 but the improvement of two kinds of first terminals 24 is substantially the same. The second/signal terminal 25 has the eye-of-needle structure, a cross section of the second terminal 25 is generally square in structure, and the second terminal 25 is typically used to transmit signals. The insulative housing 10 further defines a protruding board 15 extending forwards from the base wall 11 and between the two rows of terminals 20.

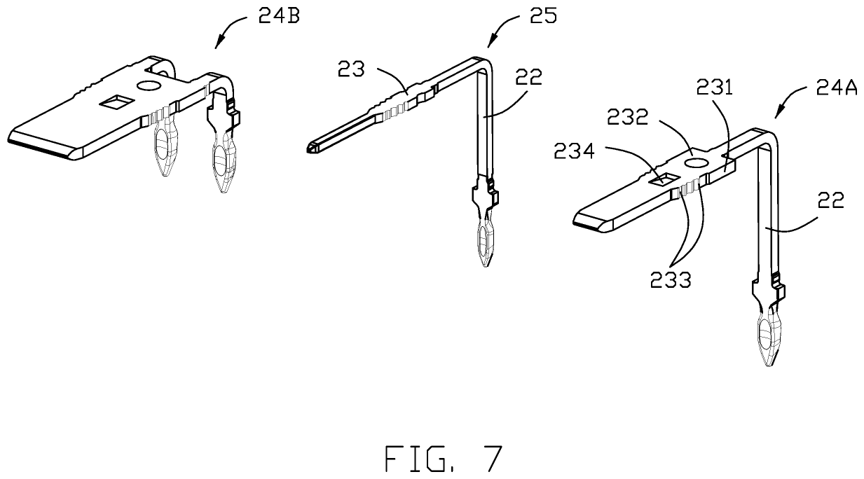

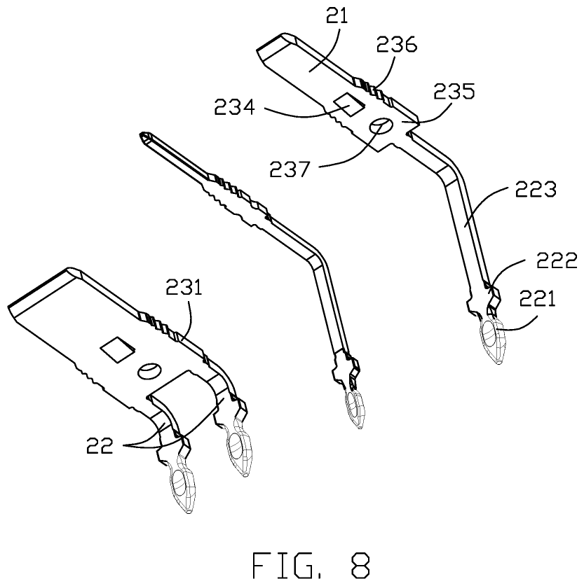

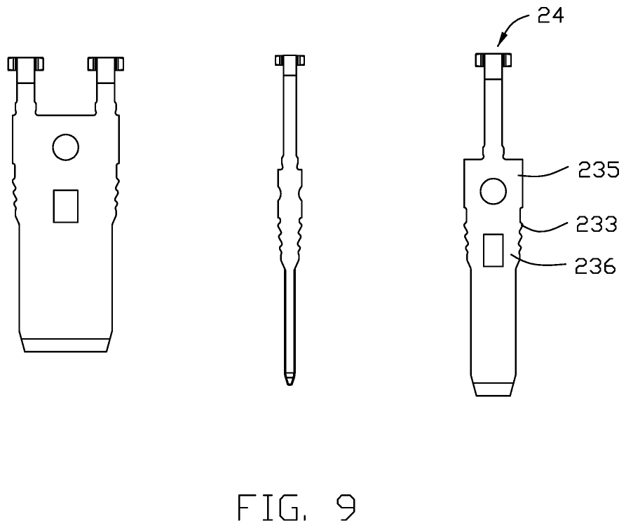

Referring to FIGS. 7-9, the fixing portion 23 of the first terminal 24A is of a flat structure, which defines two opposite narrow surfaces 231 and two opposite wide surfaces 232; that is, the wide surface 232 is larger than the narrow surface 231 in size. In the embodiment, the terminals 20 are made from a metal plate by punching; the wide surfaces 232 are two surfaces of the metal plate, and the narrow surfaces 231 are the cutting surfaces of the metal plate. The narrow surface 231 has a plurality of continuous barbs 233 which are used to be interference fit with a side of the terminal hole 13. The fixing portion 23 is punched with a tab 234 at the wide surfaces 232 from one wide surface to another wide surface. More specifically, the fixing portion 23 of the first terminal 24A includes a positioning portion 235 and a barbed portion 236 located in front of the positioning portion 235, that is, the narrow surfaces 231 of the positioning portion 235 have no barb, while the narrow surfaces 231 of the barbed portion 236 have the barbs 233. The tab 234 is located at the wide surfaces 232 of the barbed portion 236. The positioning portion 236 further defines a hole 237 running through the two opposite wide surfaces 232 thereof. The barbed portion 236 is smaller than the positioning portion 235 in a width from one narrow surface to another surface, which ensures a guiding effect during the first terminals 24A are inserted into the insulative housing forwards.

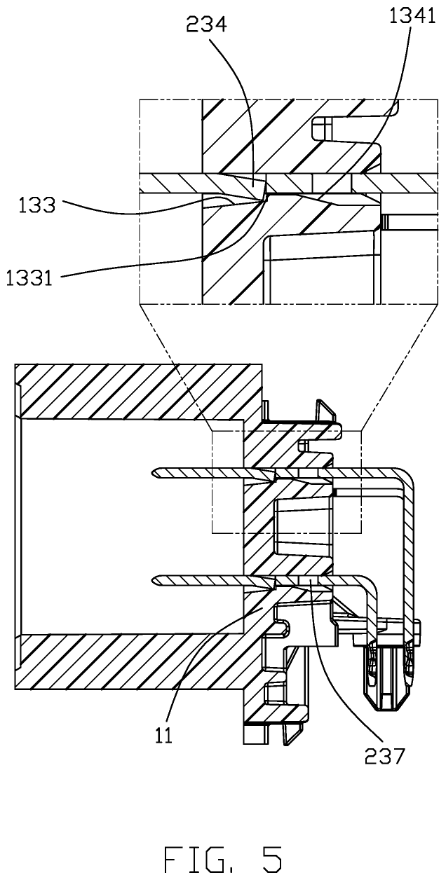

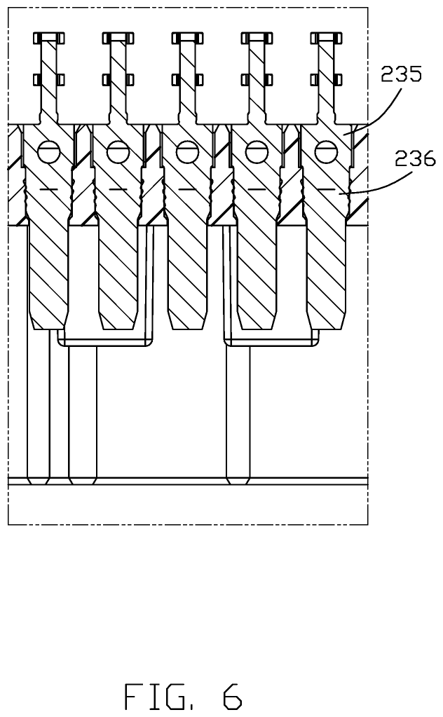

Referring to FIGS. 3-6, the terminal hole 13 passes through the front surface and the rear surface 111 of the base wall 11. The terminal hole 13 defines two opposite narrow sides 131 and two opposite wide sides 132A, 132B, one of the wide side 132A defines a front groove 133 and a rear groove 134 along the front to rear direction. The front groove 133 defines a blocking face 1331, the rear groove 134 defines a guiding face 1341. During the first terminal 24 are assembled into housing 10 from rear to front, the tabs 234 of the first terminals pass through the guiding face 1341 and the wide side 132A, and then fall into the front groove 133, the tabs 234 press rearwards against the blocking face 1331, the narrow surfaces 231 of the barbed portion 236 are interference fit with the narrow sides 131 of the terminal hole 13. As clearly shown in FIG. 6, the barbed portion 236 of the first terminal is tightly fixed in the front of the terminal hole 13 by the interference of the barbs 233, while positioning portion 235 is close to the rear of the terminal hole. Thus, the first terminal 24A is fixed in the terminal hole 13 by the interference of the barbs 233, and the tab 234 further prevents the first terminal from moving backwards.

More specifically, a middle groove 135 is further provided between the front groove 133 and the rear groove 134 and connect with the front groove and the rear groove, the middle groove 135 is lower than the face of the wide side 132A, as shown in FIG. 4, the tab 234 can pass across the middle groove 135 and fall into the front groove 133. The rear surface 111 of the terminal hole 13 defines a trumpet inclined face 137. The insulative housing 10 further defines two receiving slots 136 concaving from the rear surface 111 thereof, the receiving slots 136 are located at corners of the other wide side 132B and the corresponding narrow sides 131. After the first terminal 24A is installed in the terminal hole 13, the positioning portion 235 and the wide side 132B are space from each other with the receiving slot 136. During the first terminals 24A are assembled forwards into the terminal holes, scraped plastic burrs produced by the metallic terminals which scrap the side of the insulative housing fall into the receiving slot 136. Meanwhile, the burrs generated by the first terminal 24 during the first terminals blank, can contain in the receiving slot 136. The receiving slot 136 upwards exceeds the inclined face 137, therefore, a height between the top side of the receiving slot 136 and the wide side 132A is equal to H2, another height between the lowest side of the inclined face 137 and the wide side 132B is equal to H1, and H2>H1. In other words, the height between one wide side and the concave portion of the opposite side is greater than another height between another wide side and another concave portion of the opposite side.

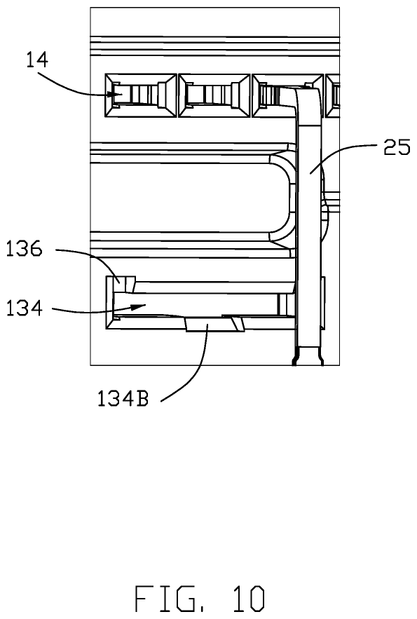

Referring to FIGS. 7-9, the soldering portion 22 bends from the rear narrow surface of the positioning portion 235, clearly, the soldering portion 22 is less than the fixing portion 23 in the width. In this embodiment, the first terminal 24A has one soldering portion 22, while the other first terminal 24B is larger than the first terminal 24A in size, and the first terminal 24B has two soldering portions 22 bending from the rear narrow surface of the positioning portion 235, the two soldering portions 22 are respectively proximate to the two opposite narrow surfaces 231 of the fixing portion 23. As shown in FIG. 10, the structure of the terminal hole 13B is substantially as same as the structure of the terminal hole 13, and comprises a front groove, a rear groove 134B and a receiving slot 136B. The terminal hole 14 receiving the second terminal 25 is different from the terminal hole 13, and the terminal hole 14 has no structure of the concave portion. The second terminal 25 is of an eye-of-needle structure, the fixing portion 23 is greater than the soldering portion 22 in the width. In the specific embodiment, the first terminals 24 are arranged in multiple rows in a vertical direction, the soldering portion 22 are different from each other in length. The soldering portion 22 in turn along the vertical direction comprises a connecting portion 223, a cross-shaped supporting portion 222 and a fish-eye shaped tail 221, the connecting portion 223 of each row of the terminals are different from each other.

While a preferred embodiment in accordance with the present disclosure has been shown and described, equivalent modifications and changes known to persons skilled in the art according to the spirit of the present disclosure are considered within the scope of the present disclosure as described in the appended claims.

What is claimed is:

1. An electrical connector comprising:
an insulative housing defining a terminal hole, the terminal hole defining two opposite narrow sides and two opposite wide sides; and
a first terminal having a fixing portion fixed in the terminal hole, the fixing portion having two opposite narrow surfaces and two opposite wide surfaces, the narrow surfaces defining barbs interference fit with the narrow sides of the terminal hole;
wherein the fixing portion further defines a tab protruding from one wide surface thereof, the terminal hole further defines a front groove with a blocking face and a rear groove with a guiding face, and the tab passes across the guiding face to press against the blocking face for preventing the fixing portion from moving rearward.

2. The electrical connector as claimed in claim 1, wherein the fixing portion of the first terminal comprises a positioning portion and a barbed portion located in front of the positioning portion, and the barbs are formed on the narrow surfaces of the barbed portion and the tab is formed on the wide surfaces of the barbed portion.

3. The electrical connector as claimed in claim 2, wherein the barbed portion is smaller than the positioning portion in a width from one narrow surface to another narrow surface.

4. The electrical connector as claimed in claim 2, wherein the positioning portion defines a hole through the two opposite wide surfaces thereof.

5. The electrical connector as claimed in claim 2, wherein the first terminal has a soldering portion bending from a rear narrow surface of the positioning portion, and the soldering portion is less in width than the fixing portion.

6. The electrical connector as claimed in claim 5, wherein the first terminal has two soldering portions bending from the rear surface of the fixing portion, and the two soldering portions are respectively proximate to the two opposite narrow surfaces of the fixing portion.

7. The electrical connector as claimed in claim 1, wherein the terminal hole defines a middle groove between the front groove and the rear groove.

8. The electrical connector as claimed in claim 1, wherein the terminal hole defines an inclined face at a rear surface thereof.

9. The electrical connector as claimed in claim 8, wherein the insulative housing defines a receiving slot concaving from the rear surface, and the positioning portion and the wide side of the first terminal are spaced from the receiving slot.

10. The electrical connector as claimed in claim 9, wherein the receiving slot extends upwards beyond the inclined face.

11. The electrical connector as claimed in claim 5, wherein the soldering portion comprises a connecting portion, a cross-shaped supporting portion, and an eye-of-needle tail.

12. An electrical connector comprising:
a housing defining a terminal hole, the terminal hole having a blocking face;
a power terminal comprising a fixing portion fixed in the terminal hole, a contacting portion, and a soldering portion, the fixing portion having two opposite first surfaces and two opposite second surfaces larger in size than the first surfaces, each of the first surfaces having barbs interference fit with the terminal hole to fitly retain the power terminal in the terminal hole;
wherein the fixing portion further defines a tab punching from one second surface to another second surface, the contacting portion goes across the terminal hole along a first direction until the bars are interference fit with the terminal hole and the tab presses against the blocking face along a direction opposite to the first direction.

13. The electrical connector as claimed in claim 12, wherein the terminal hole defines a front groove with the blocking face and a rear groove with a guiding face;, and the tab passes across the guiding face to press against the blocking face.

14. The electrical connector as claimed in claim 13, wherein the terminal hole further defines a middle groove between the front groove and the rear groove.

15. The electrical connector as claimed in claim 12, wherein the soldering portion comprises two legs.

16. The electrical connector as claimed in claim 12, wherein the fixing portion includes a barbed portion and a guiding portion, and the barbs and the tab are defined at the barbed portion while the guiding portion has no barb and is wider than the barbed portion.
